(19) United States
(12) Patent Application Publication
(10) Pub. No.: US 2015/0268818 A1
(43) Pub. Date: Sep. 24, 2015

(54) DYNAMIC MECHANISM FOR OBTAINING, UTILIZING, ANALYZING, AND DISSEMINATING USER FEEDBACK WITHIN A SOCIAL NETWORK

(71) Applicant: Begether, Inc., Cairo (EG)

(72) Inventor: Ali Mohamed Zewail, Alexandria (EG)

(73) Assignee: Begether, Inc.

(21) Appl. No.: 14/664,474

(22) Filed: Mar. 20, 2015

Related U.S. Application Data
(60) Provisional application No. 61/969,099, filed on Mar. 22, 2014.

(51) Int. Cl. G06F 3/0481; G06F 3/0484; G06F 17/30

(52) U.S. Cl. CPC G06F 3/04817; G06F 17/3053; G06F 3/04842

(57) ABSTRACT

A mechanism for positive engagement with content based on positive reinforcement.

### PRIORITY CLAIM

This patent application claims priority to U.S. Provisional Application No. 61/969,099, filed on Mar. 22, 2014, and titled “Positive Dynamic Motivating Communication Engagement Mechanism Based on Positive Reinforcement,” which is incorporated herein by reference in its entirety.

### TECHNICAL FIELD

This invention relates to social commentary in different media formats, especially in social networking. In particular, it focuses on driving social network users to engage more with positive content, hence motivating content creators to create positive content based on positive behavioral reinforcement.

### BACKGROUND OF THE INVENTION

Social networking websites, mobile apps and many other inventions allow members to connect and communicate more efficiently with their connections. These inventions allow their members to generate and/or propagate content that they see is relevant to their connections in the social network and beyond. Many of the members are passive users most of the time, they just view the content generated by their active connections. These inventions, especially social networking websites & apps, typically incorporate a system for receivers of the content to engage easily and quickly with it in the form of a user interface on the content that allows the receiver to indicate that she/he, for example, likes the content. The use of this system is ineffective in many cases where the receiver wants to express commentary that is more specific on the content, not just “like” or “thumbs up”.

In addition, these features usually have additional functionality such as subscribing the user who indicated she/he liked the content to the notification queue about actions on this particular piece of content. As such, this indication is sometimes used by the user just to subscribe to this content although they may not be liking the information inside this content, which causes ambiguity and miscommunication scenarios between connections. Moreover, this method allows people to ‘endorse’ content that is not positive in itself This causes positive feedback to be provided for content that is negative in nature.

### SUMMARY OF THE INVENTION

Embodiments of the invention make it possible for the receivers of content in any context to positively, easily and quickly engage with the content and at the same time indicate more clearly how they feel about the content. Specifically, the invention shows the content receiver positive types of descriptors for the content. By doing so, the receiver can only use the interface to give positive feedback due to the specificity of the descriptors. When the content creator receives this positive feedback, this positively reinforces the action they have taken. As such, according to the theory of reinforcement in behavioral psychology, the content creator is motivated to create more of this type of positive content in the future. Moreover, the feedback provided is more descriptive and hence more useful for the producer of the content.

In the area of social commentary on any content host, the content would include an interface that comprises several dimensions of positive feelings for the receiver to choose from. Choosing one or more of these dimensions indicates in what way she/he is engaged with the content. Moreover, this allows the aggregation of data about the content preferences of the content recipient. This data would be available for further analysis.

The descriptors chosen within the interface do not necessarily need to be constant. The content host could change the descriptors based on any number of factors (for example, content recipient, type of content, etc.).

The features and advantages described in this summary and the following detailed description are not all-inclusive. Many additional features and advantages will be apparent to one of ordinary skill in the art in view of the drawings and specifications.

### BRIEF DESCRIPTION OF THE DRAWINGS

FIG. 1 is a high-level block diagram illustrating a sample embodiment of the invention, showing the interactions between components of a sample set of systems implementing the invention.

FIG. 2 is a sequence diagram illustrating a sample embodiment of the invention, describing an interaction between content recipient and the engagement interface; and between engagement interfaces and objects on a content host.

FIG. 3 is a sequence diagram illustrating a sample embodiment of the invention, describing one way for the creation of engagement interfaces by the content host administrators.

FIG. 4 is a sequence diagram illustrating a sample embodiment of the invention, describing one way of creating of engagement interfaces by member who creates the content in the content host service.

FIG. 5 illustrates a sample embodiment of the invention, showing an example of an engagement interface requesting a member to indicate various types of feelings on text content hosted on a content host service.

FIG. 6 illustrates a sample embodiment of the invention, showing an example of an engagement interface requesting a member to indicate various types of feelings on video content within a content host service.

FIG. 7 illustrates a sample embodiment of the invention, showing an example of an engagement interface requesting a member to indicate various types of feelings on image content within content host service.

FIG. 8 illustrates a sample embodiment of the invention, showing an example of an engagement interface requesting a member to indicate different types of feelings on text content within a content host service.

FIG. 9 illustrates a sample embodiment of the invention, showing an example of an engagement interface requesting a member to indicate a rating on content within a content host service.

FIG. 10 illustrates a sample embodiment of the invention, showing an example of an engagement interface requesting a member to indicate a rating on content within a content host service.

FIGS. 11A and 11B illustrate a sample embodiment of the invention, with FIG. 11A showing unfiltered postings and FIG. 11B showing filtered postings comprising only postings that received a preponderance of a certain type of feeling from users.

FIG. 12 illustrates a sample embodiment of the invention, showing a user's profile and the number of each type of feeling that was elicited from other users in response to that user's postings.

### DETAILED DESCRIPTION OF THE PREFERRED EMBODIMENTS

There are many potential mediums for social commentary on content. One of the most common usage environments for social commentary are social networking websites and applications. However, we will address the general case of any content host. A content host is any entity that enables content creators to host content and allows the content creators to give access to this content to any content recipients. The content host can allow social commentary on such content, on behalf of the content creator. Social commentary is the capability of having content recipients provide feedback on content and to interact with it. The social commentary aspect can be provided by the content host or by another provider.

It is important to note that content is not just traditional media formats such as text, images, sound videos, etc. Content also refers to things such as actions, events, calendar entries, product descriptions, purchases, reviews, transaction information and anything that can be placed on a content host.

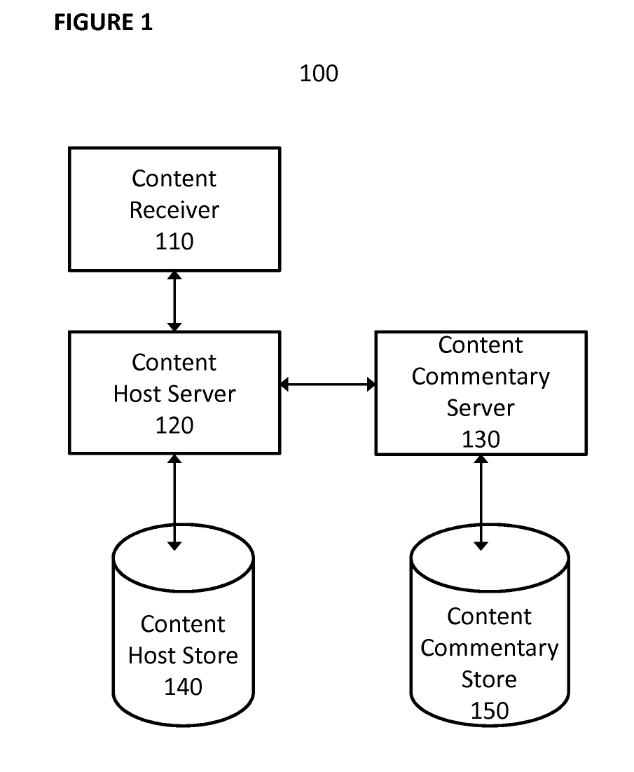

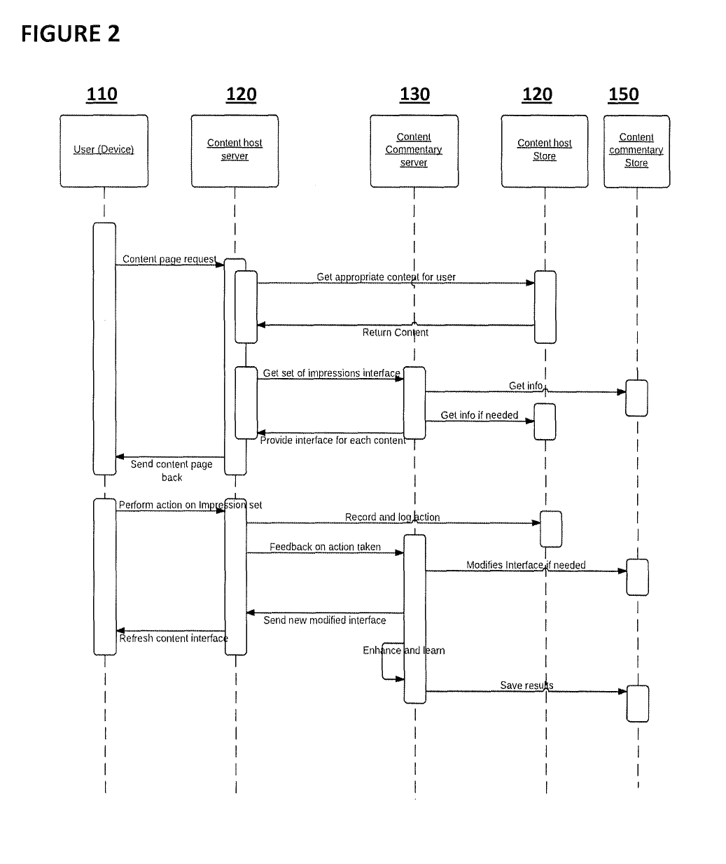

FIG. 1 illustrates an example of a high-level block diagram showing the interactions between components of a sample set of systems implementing the invention. FIG. 1 depicts social networking system 100. A sample process of ordered interactions using social networking system 100 is illustrated in FIG. 2. A member connects to the content host server 120 through a client device 110 requesting to view content. The server 120 retrieves contents from the content host store 140 to present to this user based on the specific business logic of this host service. Usually, other users of the content host service had generated the retrieved content in the first place. For every piece of content, the content host server consults a content commentary server 130 to provide the proper engagement interface for this content. Content commentary server 130 obtains relevant data from content commentary store 150, which is a repository for all comments made in social networking system 100. The content commentary server 130 uses specific logic to do this where the logic is different among invention embodiments. One example illustrating doing this job is that the content commentary server 130 triggers an impressions engagement generation algorithm to generate the required interface referring to the content host store and/or the content commentary store. The content host server 120 then adds this interface to the content interface that is accumulated for all contents to form the content feed that is then returned as the response to the user's client device request. FIG. 2 depicts exemplary requests and responses among the client device 110, content host server 120, content host store 140, content commentary server 130, and content commentary store 150.

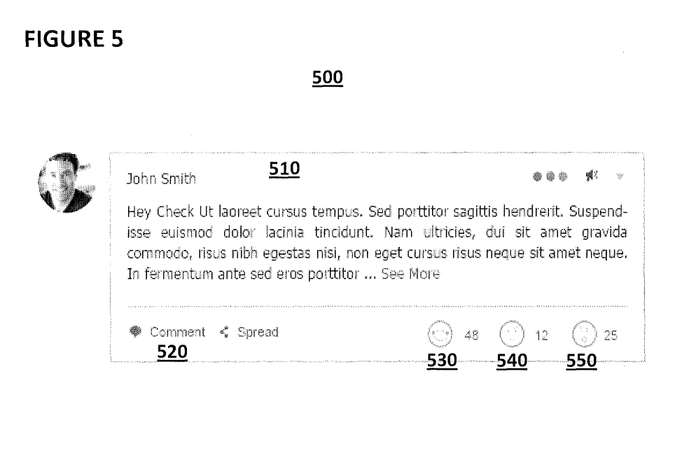

The engagement interfaces may include, for example, icons to be used as buttons to indicate different emotional or intellectual directions as shown in FIGS. 5-7. FIG. 5 depicts user interface 500, which comprises text content 510, comment button 520 (which allows the user to post a textual comment), and icons 530, 540, and 550. In this example, icon 530 represents a joyful reaction, icon 540 represents a skeptical reaction, and icon 550 depicts an amazed reaction. Icons 530, 540, and 550 also comprise a number indicating how many users have selected each type of icon in response to text comment 510 (here, 48 users have selected joyful, 12 users have selected skeptical, and 25 users have selected amazed). If the user selected a particular one of icons 530, 540, or 550, the number next to that icon will increment by one. Additional icons also can be presented, and different emotions other than these exemplary emotions can be used.

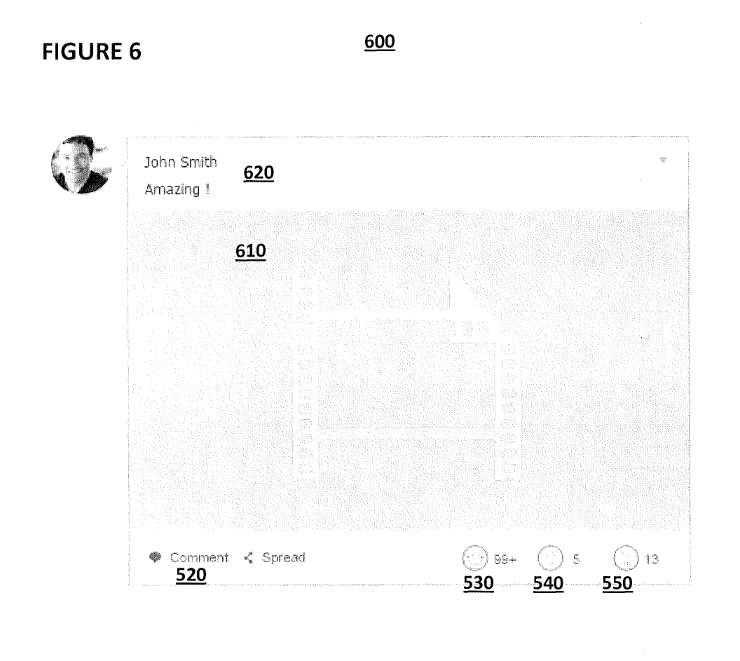

FIG. 6 depicts user interface 600 which is similar to user interface 500. Here, the posted content is video content 610, and the user has entered comment 620 in response to video content 610 after selecting the comment button 520. In this example, over 99 users have selected joyful, 5 users have selected skeptical, and 13 users have selected amazed.

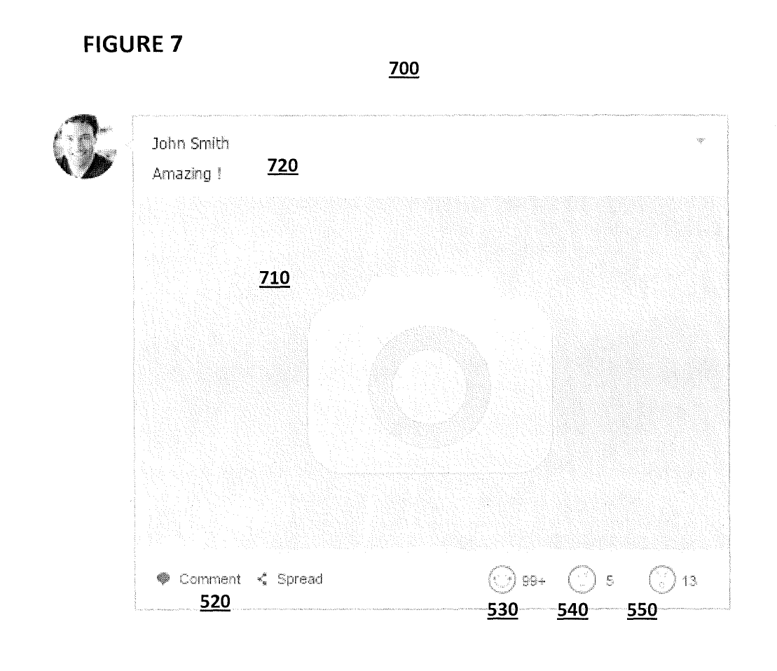

In this example, FIG. 7 depicts user interface 700 which is similar to user interface 600. Here, the posted content is photo content 710, and the user has entered comment 720 in description of photo content 710. In this example, over 99 users have selected joyful, 5 users have selected skeptical, and 13 users have selected amazed.

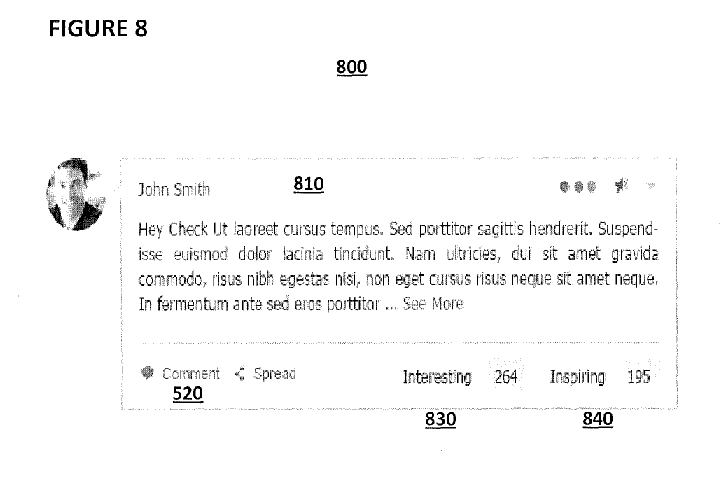

Another exemplary embodiment of an engagement interface presents list of different choices for the user to select only one of them as shown in FIG. 8. FIG. 8 depicts user interface 800. User interface 800 comprises text content 810, comment button 520 (which allows the user to post a textual comment), and response 830 and response 840. In this example, response 830 represents a reaction of “Interesting,” and response 840 represents a reaction of “Inspiring.” Responses 830 and 840 also comprise a number indicating how many users have selected each type of icon in response to text comment 810 (here, 264 users have selected “Interesting,” and 195 users have selected “Inspiring”). If the user selected a particular one of responses 830 or 840, the number next to that icon will increment by one. Additional responses also can be presented, and other responses other than these exemplary responses can be used. As in FIGS. 6-7, text content 810 can be replaced with video content or photo content.

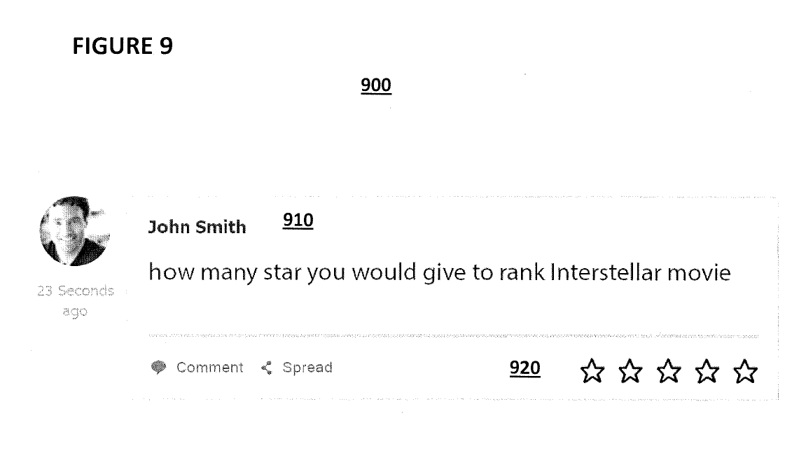

Another exemplary embodiment of an engagement interface presents a rating mechanism for the content as shown in FIG. 9. FIG. 9 depicts user interface 900. User interface 900 comprises text content 910 and ratings interface 920. A user who views text content 910 can provide a rating using ratings interface 920 regarding that text content 910. Here, ratings interface 920 allows a user to a post a rating ranging from 0 stars to 5 stars.

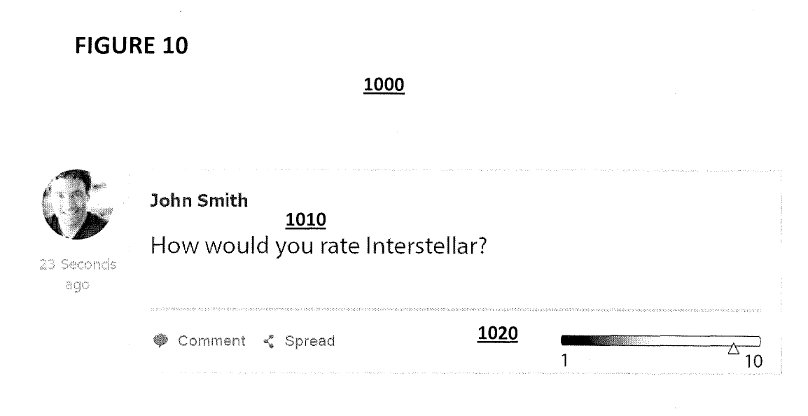

Another exemplary embodiment of an engagement interface presents a color coded mood mechanism to allow the user to indicate to how this content changed her/his mood as shown in FIG. 10. FIG. 10 depicts user interface 1000. User interface 1000 comprises text content 1010 and response interface 1020. A user who views text content 1010 can provide a response using response interface 1020 regarding that text content 1010. Here, response interface 1020 allows a user to select an entry using a sliding scale. The system can provide any number of different meanings for the sliding scale, for example: positive feelings on the right and negative feelings on the left; a high rating on the right (similar to 5 stars) and a low rating on the left (similar to 0 stars); etc.

When the user expresses a certain emotion or descriptive feedback towards a piece of content using an interface such as the ones shown in FIGS. 5-10, the content producer/originator is informed. This serves as a motivator for the content producer/generator to generate or introduce more content that stimulates this emotion. In other words, this serves as positive reinforcement for the content generator to produce more content of this type. Consequently, if the emotion options provided to engage with the content published are of the positive type, then a motivator to produce positive content (positive reinforcement) has been created.

When the content receiver engages and interacts with the impressions engagement interface, the user's client device 110 accordingly sends a request to the content host server 120 to communicate to it this action through the logic of the specific engagement interface present. The content host server 120 logs this action to its store 140 and then passes this information to the content commentary server 130 for processing. According to the embodiment specific logic, it will perform changes to its store 150. Numerous possible dynamic scenarios can be implemented here implementing features for the content host 120. Some of them already exist in current hosts like subscribing this user to the notifications about actions taken on this content by other members. Others are new features that are now possible through this invention, like for example, subscribing only to the similar actions on the content, hence providing notifications that are more relevant.

As a response to the user's client device request, the content commentary server 130 may provide the content host server 120 with a modified (or even new) engagement interface to be presented to the user on this piece of content. For example to indicate to the user the action she/he took. Another example maybe to change the interface to allow other indications and/or actions based on the specific business logic of the implemented content commentary server.

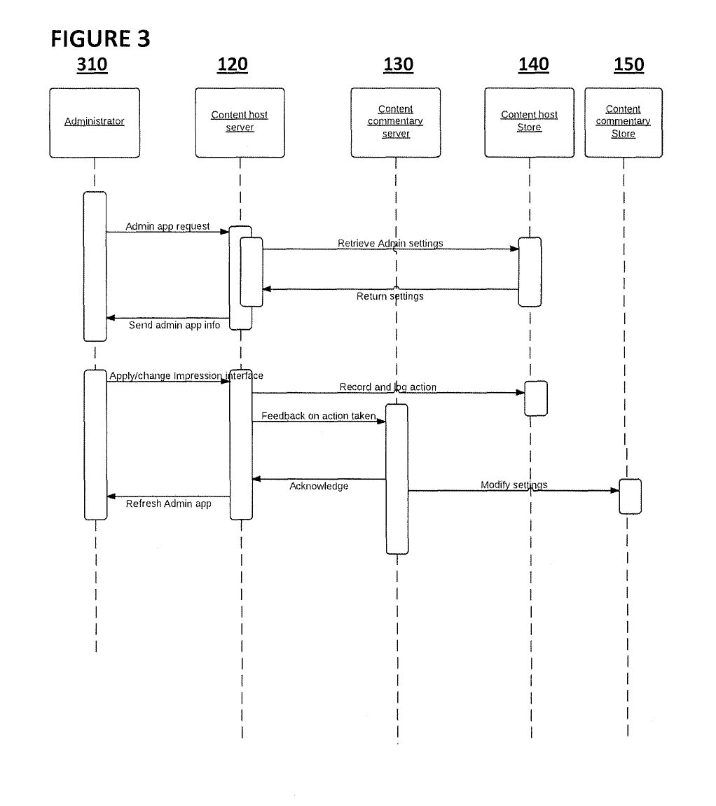

Impressions engagement interfaces may be created by different ways. FIG. 3 illustrates one alternative where the content host administrators use an administrator application on administrator device 310 to create the interfaces. Administrators may select which actions a member may perform from within the impressions engagement interface using the application. After selecting the performable actions, the engagement interface is associated with the appropriate objects in the store in order for the selection of the link to perform the action within the engagement interface to modify the correct object. Alternatively, the content commentary server may create a number of impressions engagement interfaces in a batch process triggered by the administrators or content host users and then store these interfaces in its store. This way, a set of engagement interfaces is ready to be provided for each member without having to be created in real time. This helps with the scalability of the content host service.

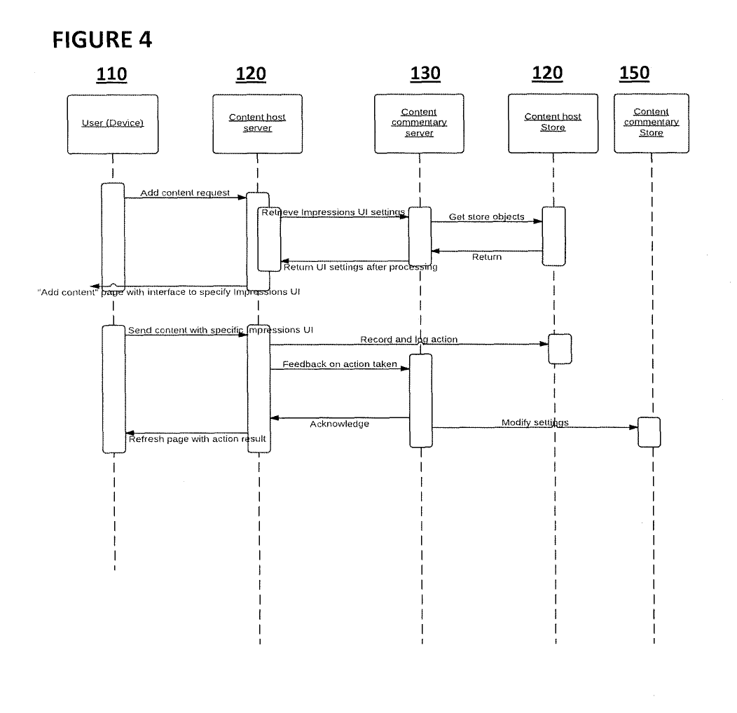

FIG. 4 illustrates another option where this implementation gives the member who created the content the ability to specify an impressions engagement interface to be associated with her/his content.

### ILLUSTRATIVE EXAMPLE

An illustrative example to this can be as follows, while watching a certain program/movie on an interactive TV (also occasionally referred to as a Smart TV), the user can receive an impressions engagement interface (similar to those of FIGS. 5-10) on the screen of client device 110 to specify her/his impression towards this program. When engaging with the interface, the TV system can then communicate with the social network and post the user's impression either on the user's page, a community page and/or the official page of the program on the social network. A scenario for deciding the specific impression engagement interface can be that the program/movie page owner on the social network specify the details of the engagement interface that she/he wants to present to the social network members who will be viewing the program on their smart TVs. Other scenario could be as direct and static as having only one type of the impressions engagement interface can be pre-built on the TV remote control.

The embodiments described herein will enable users to quickly express their views, reactions, or feelings regarding content with a single click in a more sophisticated and nuanced way that simply saying that you “like” the content. Content commentary server 130 can aggregate the collected data to show how many users reacted to the content in each particular way. Content commentary server 130 also can create feeds that generated a specific type of reaction in a number of users over a certain threshold (e.g., sending all news feeds that generated a happy reaction in more than 40% of all users who posted a reaction).

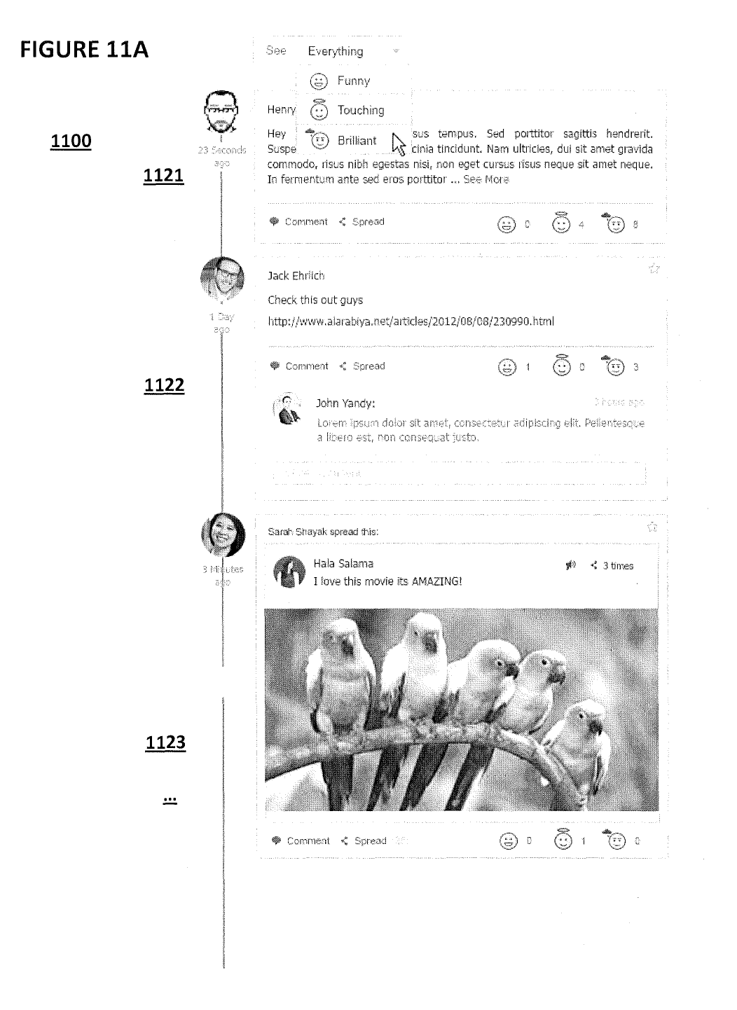

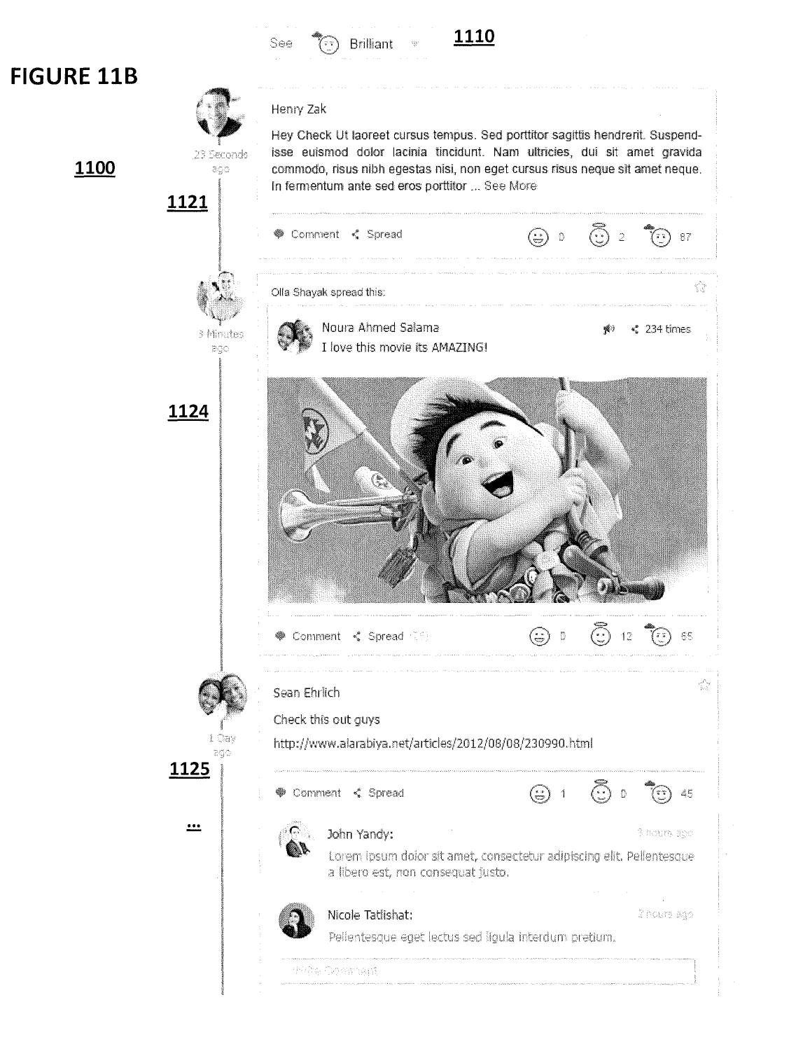

For example, in FIGS. 11A-B, user interface 1100 is depicted. User interface 1100 provides selection mechanism 1110, which allows a user to filter the postings based on one of a plurality of reactions. For example, the user could select “brilliant” as a filter, and the system then would show only postings that generated a threshold value of a certain reaction, for example, postings or news feeds that generated a “brilliant” reaction from a majority of users who posted a reaction. Other filter options in this example include “touching” and “funny,” and any number of different icons or descriptors could be used as filters.

In FIG. 11A, user interface 1100 depicts unfiltered postings comprising exemplary postings 1121, 1122, and 1123. In FIG. 11B, user interface 1100 depicts filtered postings using “brilliant” as a filter. The filtered postings comprise exemplary postings 1121, 1124 and 1125, each of which received a “brilliant” ratings more than any other type of rating.

Content commentary server 130 also can provide a score for users who post comments, for example, by indicating how much of each emotion is generated in response to the user's comments. Content commentary server 130 also can inform its users which posting of content generated the most of a particular emotion in a particular time period (e.g., the content that generated the most responses in one day indicating the content is funny).

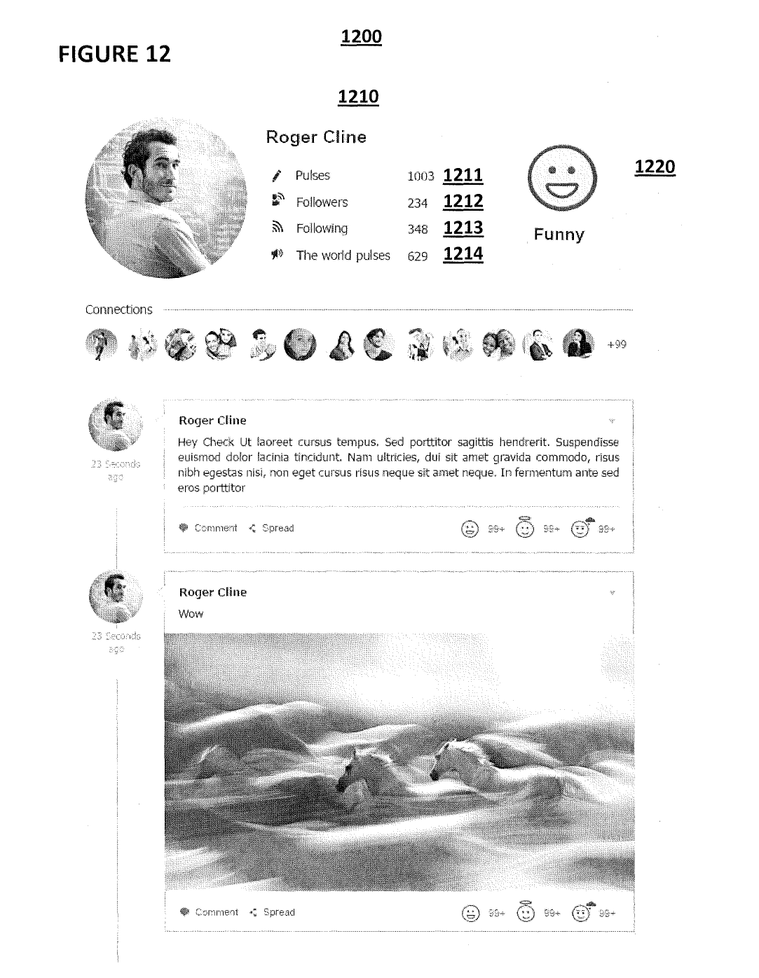

For example, in FIG. 12, profile 1200 is depicted for an exemplary user. Profile 1200 displays postings data 1210, such as number of posts by that user to his or her social network (1211), number of followers (1212), number of people he or she is following (1213), and number of posts by that user to the general public (1214). Content commentary server 130 generates an overall score 1220 for the user associated with profile 1200. For example, the score can indicate the reaction that the user elicited the most often in response to his or her postings. Here, the predominant reaction was “Funny.” This can be useful if a user wants to see which of the members of his or her social network elicits a certain type of reaction the most often. For example, which friends are “Funny,” which friends are “Brilliant,” “Touching,” “Amazing,” “Inspiring,” etc.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims.

What is claimed is:

1. A system for obtaining and aggregating user feedback, comprising:
a server for providing a user interface on a client device, the user interface displaying content posted by a first user and presenting a second user with a plurality of selectable icons and/or descriptors and an indication of the numbers of users who have selected each of the plurality of selectable icons and/or descriptors for the content.

2. The system of claim 1, wherein the plurality of selectable icons or descriptors comprises at least two icons or descriptive words.

3. The system of claim 1, wherein each of the plurality of selectable icons and/or descriptors can be selected using a single click.

4. The system of claim 1, wherein the content comprises text data.

5. The system of claim 1, wherein the content comprises video data.

6. The system of claim 1, wherein the content comprises image data.

7. The system of claim 1, wherein the content comprises sound data.

8. The system of claim 1, wherein the content comprises any combination of text, video, image and sound data.

9. The system of claim 1, wherein the indication comprises textual numbers.

10. The system of claim 1, wherein the server is configured to generate a feed comprising content that has generated a number or percentage of users over a predetermined threshold who have selected a particular icon or descriptor.

11. The system of claim 1, wherein the server is configured to generate a score for the first user indicating the number or percentage of users who have responded to the first user's content by selecting a particular icon or descriptor.

12. The system of claim 1, wherein the server is configured to disseminate content that generated the largest number of selections of a particular icon or descriptor over a time period.

13. A method for obtaining and aggregating user feedback, comprising:
receiving, on a first client device, content from a first user;
transmitting, by the first client device, the content to a server;
transmitting, by the server, the content to a second client device;
providing, by the second client device, a user interface;
displaying, in the user interface, the content and a plurality of selectable icons and/or descriptors and an indication of the numbers of users who have selected each of the plurality of selectable icons and/or descriptors for the content;
receiving, on the second client device, a selection of one of the plurality of selectable icons or descriptors; and
updating, in the user interface, the indication of the number of users who have selected the one or more of the plurality of selectable icons or descriptors.

14. The method of claim 13, wherein the plurality of selectable icons and/or descriptors comprises at least two icons or descriptive words.

15. The method of claim 13, wherein each of the plurality of selectable icons and/or descriptors can be selected using a single click.

16. The method of claim 13, wherein the content comprises text data.

17. The method of claim 13, wherein the content comprises video data.

18. The method of claim 13, wherein the content comprises image data.

19. The system of claim 1, wherein the content comprises sound data.

20. The system of claim 1, wherein the content comprises any combination of text, video, image and sound data.

21. The method of claim 13, wherein the indication comprises textual numbers.

22. The method of claim 13, further comprising:
generating, by the server, a feed comprising content that has generated a number or percentage of users over a predetermined threshold who have selected a particular icon or descriptor.

23. The method of claim 13, further comprising:
generating, by the server, a score for the first user indicating the number or percentage of users who have responded to the first user's content by selecting a particular icon or descriptor.

24. The method of claim 13, further comprising:
disseminating, by the server, content that generated the largest number of selections of a particular icon or descriptor over a time period.
